(19) United States
(12) Patent Application Publication
(10) Pub. No.: US 2011/0189987 A1
(43) Pub. Date: Aug. 4, 2011

(54) METHOD FOR FEMTO-CELL IDENTIFICATION

(75) Inventors: Wenfeng Zhang, Plano, TX (US); Yonggang Fang, San Diego, CA (US)

(73) Assignee: ZTE (USA) INC.

(21) Appl. No.: 13/057,740

(22) PCT Filed: Aug. 6, 2009
(86) PCT No.: PCT/US09/53045

§ 371 Date: Apr. 22, 2011

(30) Foreign Application Priority Data
Aug. 6, 2008 (US) 61086752
Aug. 18, 2008 (US) 61089778

(51) Int. Cl. H04W 4/00

(52) U.S. Cl. 455/422.1

(57) ABSTRACT

Methods and systems for femto-cell identification are disclosed herein. In one embodiment, a femto-cell base station is adapted to transmit with each broadcast a value which maps one-to-one to a different portion of a femto-cell identification. After the mobile station reports each broadcasted value to the serving non-femto-cell, the target femto-cell identification can be determined by combining multiple reports. In this manner, a fairly large identification space can be provided without significant increases in implementation complexity. In some embodiments, the system does not introduce issues with backward compatibility since standard cell identification procedures are preserved. In some embodiments, knowledge of the maximum number of femto-cells within a non-femto-cell is not required, thereby preventing ambiguous hand-in targets.

### CROSS-REFERENCE TO RELATED APPLICATIONS

This application claims priority to U.S. Provisional Patent Application No. 61/086,752 filed on Aug. 6, 2008, entitled “System and Method for Femto-cell Identification,” and to U.S. Provisional Patent Application No. 61/089,778 filed on Aug. 18, 2008, entitled “System and Method for Femto-cell Identification,” the contents of which are incorporated by reference herein in their entirety.

### FIELD OF THE INVENTION

The present invention relates generally to the field of digital communications. More particularly, various aspects of the present invention are directed to femto-cell identification within a wireless communications network.

### BACKGROUND OF THE INVENTION

In wireless communications systems, coverage areas are provided by a number of discrete cells. These cells are traditionally categorized as macro-cell, micro-cell, or even pico-cell depending on the cell size. Recently, an even smaller cell type known as a femto-cell has become of particular interest. A femto-cell provides enhanced capacity and indoor coverage over a relatively small geographic area (for example, covering a residential home or office area).

There may be many femto-cells contained within a larger cell. Each femto-cell is supported by a respective Base Station (BS) which provides a wireless access point for one or more mobile stations (MS) that are within its communicative range. A mobile station generally refers to a mobile user terminal (for example, a mobile phone) which can wirelessly communicate with one or more base stations according to its present location.

When a mobile station changes its location within a non-femto-cell such that it moves within a femto-cell, the mobile station can detect the availability of the femto-cell and request a handoff (denoted as a hand-in) from the non-femto-cell to the femto-cell for the purpose of attaining better coverage. In order to accomplish this, however, the mobile station must first inform the wireless network of two pieces of information: (a) whether the detected available target cell is in fact a femto-cell, and (b) the identification of that femto cell.

Certain conventional devices allow each femto-cell to carry both a femto-cell flag and a femto-cell identification within the femto cell's broadcast channel. However, reading a femto-cell's broadcast channel before a handoff can degrade handoff performance. Certain alternative solutions therefore attempt to read this information directly from the physical layer. According to one such method, for example, the cell identification space is increased and the total identification space is partitioned into separate subsets: one subset for femto-cell identification, and the other subset for non-femto-cell identification. Thus, by analyzing the total identification space, the mobile station can determine both identification values.

This method, however, has at least three drawbacks. First, increasing and partitioning the identification space usually requires modifying an existing standard and therefore introduces issues with backward compatibility. Second, increasing the identification space and performing associated partitioning requires additional logic for detecting each of the separate identifications from the total identification space. Third, since it is difficult to predict the maximum number of femto-cells that could ever exist within a non-femto-cell, it is likewise difficult to determine the precise level of expansion necessary to the identification space such that each femto-cell is guaranteed to have a unique identification. In practical application, when the number of femto-cells within a non-femto-cell is so large that cell identifications have to be reused, the problem of an ambiguous hand-in target can arise.

### SUMMARY OF THE INVENTION

Various embodiments of the present invention are therefore directed to methods and systems for identifying a femto-cell while avoiding one or more of the aforementioned drawbacks. In some embodiments, the mobile station is adapted to directly detect the femto-cell's identification over the physical layer.

Without changing the standard cell identification (denoted throughout this description as cell-id), various embodiments of the present invention define a femto-cell identification in the form of <cell-id, extra-femto-id>, where the extra-femto-id can be an independent identification space from cell-id. In some embodiments, the femto-cell broadcasts cell-id in the same way as a non-femto-cell. In order to indicate the extra-femto-id, however, the femto-cell may broadcast one value at a time. Each value may then be mapped one-to-one to a separate portion of extra-femto-id. The mobile station can then determine whether the cell is a femto-cell or a non-femto-cell based upon the existence of this broadcast and report these values to the non-femto-cell for hand-in purposes. The serving non-femto cell or network can then unambiguously determine the target femto-cell identification by combining these reported values. Hence, as the number of combined report values increases, the total identification space is enlarged, effectively yielding a scalable system that can guarantee unique identifications for each femto-cell that is disposed within an overlaying non-femto-cell.

In a first aspect of the invention, a cell identification method is disclosed. In some embodiments, the femto-cell identification is in format of <cell-id, extra-femto-id>, where cell-id is in the same format as a non-femto-cell identification.

In a second aspect of the invention, a cell identification broadcast method is disclosed. In some embodiments, each broadcast signaling carries a value that maps one-to-one to a different portion of cell identification, and the original cell identification can be unambiguously recovered by combining multiple broadcast values. Mathematically, the k-th femto-cell broadcasts <cell-idₖ, sₖⁱ> which is detected and reported by the mobile station to the serving non-femto-cell. The serving non-femto-cell then combines these reports into a single unambiguous identification in the form <cell-idₖ, Sₖ(M)= [symbol] sₖ⁰, . . . , sₖ^{M-1} [symbol] >.

In some embodiments, the cell identification broadcast signaling contains the pair of <cell-id, s>, where sεZ≡{x₀, x₁, . . . , x_{N-1}, null} and <cell-id, s=null> is equivalent to cell-id itself The non-femto-cell broadcasts the pair <cell-id, null>, while the femto-cell broadcasts the pair <cell-id, s≠null>.

In some embodiments, the cell identification broadcast signaling contains the pair of <cell-id, s>, where sεZ≡{x₀, xₗ, . . . , x_{N-1}} and <cell-id, s=x₀> is equivalent to cell-id itself, where x₀ indicates any specific elements in Z. The non-femto-cell broadcasts the pair of <cell-id, s=x₀>, while the femto-cell broadcasts the pair of <cell-id, s≈x₀>.

In some embodiments, the same value of sₖⁱ is used in one or multiple broadcast signaling during one time window so that soft-combination can be used at receiver to enhance reception performance.

In some embodiments, the k-th femto-cell broadcast in i-th time window the signature sequence y(sₖⁱ)=aᵢ·cₖ where sequence aᵢ belongs to a sequence set whose N member sequences have low cross-correlations, cₖ is uniquely determined by cell specific parameters such as cell-id, and multiplication is performed element-wise.

In some embodiments, the k-th femto-cell broadcasts in i-th time window the sequence y(sₖⁱ)=aᵢ·cₖ, where aᵢ belongs to an N-ary orthogonal Walsh or Hadamard sequence set or length-N maximum-length binary sequence (m-sequence), and cₖ is generated from an m-sequence or a Gold sequence whose initial state or state mask or cyclic delay is uniquely mapped to cell-id.

In some embodiments, the reserved subcarriers aside P-SCH and S-SCH (where SCH refers to a synchronization channel) are used to carry signaling y(sₖⁱ) in a 3^{rd} Generation Partnership Project (3GPP) Long Term Evolution (LTE) Frequency Division Duplexing/Time Division Duplexing (FDD/TDD) system.

In some embodiments, if an N-ary orthogonal sequence is chosen to construct y(sₖⁱ) in a 3GPP-LTE FDD/TDD system, then Nε{2,4,8,16,32}, and the sequence is repeated

$$⌊ \frac{40}{N} ⌋$$

times. The

$$N \cdot ⌊ \frac{40}{N} ⌋$$

used subcarriers and

$$40 - N \cdot ⌊ \frac{40}{N} ⌋$$

unused subcarriers may be evenly distributed over four SCH symbols per frame. In each SCH time symbol, the subcarriers used to carry y(sₖⁱ) may be adjacent to the SCH subcarriers or isolated from SCH by unused subcarriers (if there are any).

In some embodiments, if a length-N m-sequence is used to construct aᵢ in a 3GPP-LTE FDD/TDD system, Nε{3,7,31} but can be rounded up to nearest power of 2 by modifying m-sequence to M-sequence, and the sequence is repeated

$$⌊ \frac{40}{N} ⌋$$

times. The

$$N \cdot ⌊ \frac{40}{N} ⌋$$

used subcarriers and

$$40 - N \cdot ⌊ \frac{40}{N} ⌋$$

unused subcarriers are evenly distributed over four SCH symbols per frame. In each SCH time symbol, the subcarriers used to carry y(sₖⁱ) can be either adjacent to SCH subcarriers or isolated from SCH by unused subcarriers (if there are any).

In some embodiments, in constructing signaling y(sₖⁱ), cell-specific cₖ has two versions, cₖ^{odd} and cₖ^{even}. Each version's value is continually used for the same signature sequence aᵢ and alternatively changes when aᵢ changes.

In a third aspect of the invention, a method to determine the value of s is disclosed. In some embodiments, s can be dynamically reported to the femto-cell by network elements such as via the overlaying non-femto-cell or a femto-server. The femto-cell may continually use the reported s value to generate identification broadcast signaling until it receives a new value of s which overrides the existing one.

In some embodiments, s can be autonomously generated by a femto-cell itself according to a mapping function ƒ: seedₖ→Sₖ. This semi-static parameter known as a “seed” is controlled by one or more network elements such as femto-server or the overlaying non-femto-cell. The mapping function can be a one-to-one mapping such that the full identification <cell-idₖ, Sₖ> is equivalent to <cell-idₖ, seedₖ>.

In some embodiments, where the seed has m bits if in binary format, the mapping function ƒ: seedₖ→Sₖ can be realized by mapping each seed to an initial state (or equivalently to a cyclic delay or state mask) of a maximum-length sequence (m-sequence) generator constructed by m shift registers. Every n=log₂ N (where N is assumed as integer power of 2) continuous binary bits from the generator output are then grouped to form an integer so that the overall generator output binary stream maps to a integer series Sₖ= [symbol] . . . sₖⁱ, sₖⁱ⁺¹ . . . [symbol] , the mapping function output. For identification broadcast signaling generated through this mapping function, the mobile station performs detections within

$$M \geq ⌈ \frac{m}{n} ⌉$$

continuous time windows.

In a fourth aspect of the invention, a method for mobile station report detection is disclosed. In some embodiments, the mobile station can add the detection results into existing handoff request signaling which is sent to a serving non-femto-cell base station.

In some embodiments, each report includes the time stamp in the accuracy of frame or time window which indicates when the corresponding detection is performed. In some embodiments, detection results within multiple time windows are bundled into one report.

In some embodiments, after the hand-in procedure has been initiated, the mobile station continuously detects and reports to the serving non-femto-cell base station until it receives a handoff command from the base station.

In a fifth aspect of the invention, a method of processing a mobile station detection report is disclosed. In some embodiments, upon receiving a report from a mobile station, the serving non-femto-cell base station determines if the target femto-cell can be unambiguously identified by this report and all previous reports issued from the mobile station. If the target cell can be unambiguously identified, the non-femto-cell base station sends a handoff command to the mobile station. According to one variant, if the target cell cannot be unambiguously identified, the base station sends a command to the mobile station requesting an additional detection report. According to another variant, if the target cell cannot be unambiguously identified, the base station simply waits to receive an additional report from the mobile station.

In a sixth aspect of the invention, a method of communicating detection parameters to a mobile station is disclosed. In some embodiments, the serving non-femto-cell delivers some or all of following information to a mobile station on either a dedicated channel or through common channels: the alphabetic size of signature set Z (N), the time window length in unit of frame (L), and the number of time windows (M) that is large enough to ensure unambiguous identification of each femto-cell.

These and other implementations are described in greater detail with reference to the following claims, detailed description, and attached drawings.

### BRIEF DESCRIPTION OF THE DRAWINGS

FIG. 1 is a block diagram illustrating an exemplary network arrangement for femto-cell identification according to one embodiment of the present invention.

FIG. 2 is a block diagram illustrating an exemplary femto-cell base station adapted to transmit broadcast data according to one embodiment of the present invention.

FIG. 3 is a flow diagram illustrating an exemplary method of transmitting a set of values used for femto-cell identification according to one embodiment of the present invention.

FIG. 4 is a transmission sequence diagram illustrating an exemplary synchronization channel structure in a 3GPP/LTE FDD system with the reserved subcarriers carrying signaling information according to one embodiment of the invention.

FIG. 5A is a block diagram illustrating an exemplary femto-cell architecture where a non-femto cell base station directly controls the identification broadcast by a femto-cell according to one embodiment of the invention.

FIG. 5B is a block diagram illustrating an exemplary femto-cell architecture where a femto server directly controls the identification broadcast by a femto-cell according to one embodiment of the invention.

FIG. 6 is a block diagram illustrating an exemplary system for generating broadcast signaling using dynamic full-control according to one embodiment of the present invention.

FIG. 7A is a block diagram illustrating an exemplary femto-cell architecture where a non-femto-cell base station 106 controls the identification broadcast by a femto-cell by a semi-static parameter according to one embodiment of the invention.

FIG. 7B is a block diagram illustrating an exemplary femto-cell architecture where a femto server controls the identification broadcast in femto-cell by a semi-static parameter according to one embodiment of the invention.

FIG. 8 is a block diagram illustrating an exemplary system for generating broadcast signaling using semi-static seed control according to one embodiment of the present invention.

FIG. 9 is a flow diagram illustrating an exemplary method of processing mobile station reports at a non-femto-cell base station according to one embodiment of the present invention.

### DETAILED DESCRIPTION OF EXEMPLARY EMBODIMENTS

Various embodiments of the present invention are now described in detail with reference to the following figures. The figures provided herein are for the purposes of illustration and should not be considered limiting in terms of breadth, scope, or applicability of the disclosure. For clarity and ease of illustration, not all of the figures have been drawn to scale.

Note that while various embodiments are described herein in terms of identifying a femto-cell within a 3GPP Long Term Evolution (LTE) system, the present invention is not limited to such applications, and may be used in a wide variety of other systems as well (including, for example, 3rd Generation Partnership 2 (3GPP2) systems).

Note also that different wireless technologies often utilize different naming conventions for referring to a femto-cell and other network entities. For example, in the 3GPP/LTE standard, a femto-cell may be referred to as a Closed Subscriber Group (CSG) cell. A base station may be referred to as a eNB (enhanced NodeB) in the 3GPP/LTE standard, or part of an AN (access network) in the 3GPP2 standard. Additionally, a Mobile Station may be referred to as UE (User Equipment) in the 3GPP standard, or called an AT (Access Terminal) in 3GPP2. The use of such language within this disclosure is not intended to be limiting, and is used here only for exemplary purposes. It is to be understood that embodiments of the present invention may be used according to other standards and applications as well.

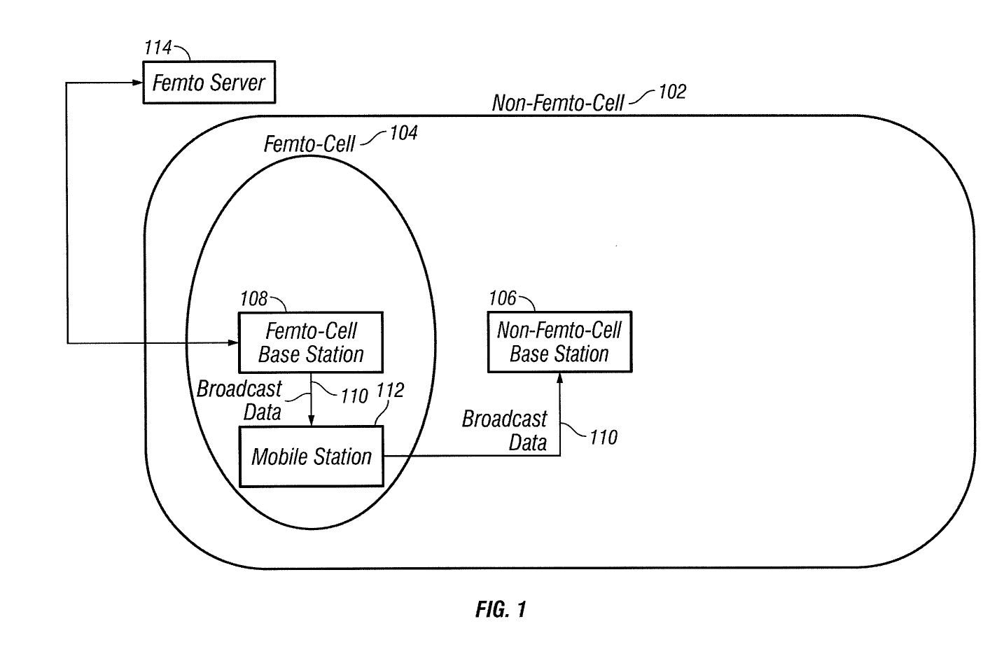

FIG. 1 is a block diagram illustrating an exemplary network arrangement for femto-cell identification according to one embodiment of the present invention. As shown by the figure, the communicative range of the non-femto-cell base station 106 is illustrated by non-femto-cell 102, while the communicative range of femto-cell base station 108 is illustrated by femto-cell 104. A remotely located femto server 114 may support any number of femto-cell base stations situated within the non-femto-cell 102. Note that while only one femto-cell base station 108 is depicted within the non-femto-cell 102 of FIG. 1, it is to be understood that the non-femto-cell 102 could encompass any number of femto-cell base stations 108, and therefore any number of femto-cells 104. In some embodiments, the communicative range of the femto cells 104 may even overlap in certain regions.

When a mobile station 112 within the non-femto-cell 102 relocates from outside of a femto-cell 104 to inside of the femto-cell 104, it may then detect that a new cell is available and request a handoff to the available cell for the purpose of attaining better coverage. In order to accomplish this, however, the mobile station 112 must first inform the non-femto-cell base station 106 of two pieces of information: (a) whether the detected available target cell is in fact a femto-cell, and (b) the identification of the femto cell.

In order to accomplish this, the mobile station 112 may receive periodic broadcasts from the femto-cell base station 108 and relay these broadcasts to the non-femto-cell base station 106. Each broadcast may include a set of broadcast data 110 containing a separate value. After the non-femto-cell base station 106 has received a sufficient number of such values, the non-femto-cell base station 106 may then process these values in order to determine the identification of the femto-cell 104.

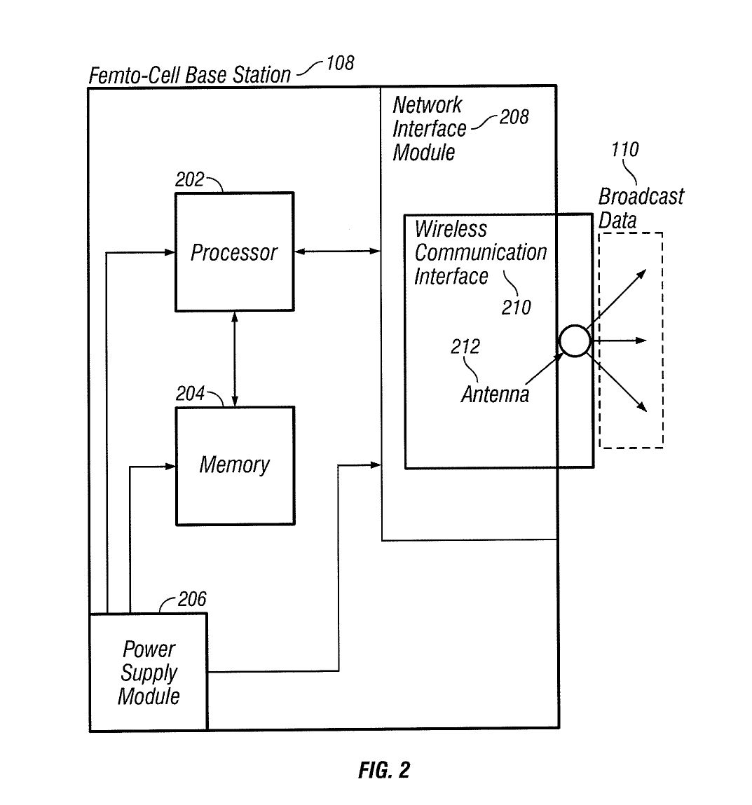

FIG. 2 is a block diagram illustrating an exemplary femto-cell base station 108 adapted to transmit broadcast data 110 according to one embodiment of the present invention. As shown in the figure, the femto-cell base station 108 may include a processor 202, memory 204, a power supply module 206, and a network interface module 208 including a wireless communication interface 210.

The power supply module 206 provides a source of power to modules disposed within the femto-cell base station 108. In some embodiments, power is supplied externally by one or more conductive wires, for example, from a power cable or a serial bus cable. In other embodiments, a battery may be used as a source of power.

Memory 204 includes any type of module adapted to enable digital information to be stored, retained, and retrieved, and may include any combination of volatile and non-volatile storage devices, including without limitation RAM, DRAM, SRAM, ROM, and/or flash memory. Additionally, memory 204 may be organized in any number of architectural configurations utilizing, for example, registers, memory caches, data buffers, main memory, mass storage, and/or removable media.

One or more processors 202 are adapted to execute sequences of instructions by loading and storing data to memory 204. Possible instructions include, without limitation, instructions for data conversions, formatting operations, communication instructions, and/or storage and retrieval operations. Additionally, the one or more processors 202 may comprise any type of digital processing devices including, for example, reduced instruction set computer processors, general-purpose processors, microprocessors, digital signal processors, gate arrays, programmable logic devices, reconfigurable compute fabrics, array processors, and/or application-specific integrated circuits. Note also that the one or more processors 202 may be contained on a single unitary IC die or distributed across multiple components.

A network interface module 208 enables data to be transmitted and/or received between two or more devices. In some embodiments, the network interface module 208 may include a wireless communication interface 210 with an antenna 212 for communicating with one or more mobile stations. Communication associated with the wireless communication interface 210 may be governed by one or more communication protocols, including, without limitation, 3GPP/LTE and 3GPP2. Note, however, that various other communication and/or network protocols may be used according to the scope of the present invention.

An exemplary process of broadcasting values which may be used to determine the identification of a femto-cell 104 is now described. In some embodiments, each cell identification broadcast signaling contain a pair of <cell-id, s>, where sεZ≡{x₀, x₁, . . . x_{N-1}, null} and <cell-id, s=null> may be equivalent to cell-id itself. In this manner, a non-femto-cell base station 106 can broadcast the pair of <cell-id, null>, while a femto-cell base station 108 can broadcast the pair of <cell-id, s≠null>. By detecting whether or not the broadcast s is null, a mobile station 112 can thus determine whether or not the detected cell is a femto-cell 104 or a non-femto cell 102.

In alternative embodiments, sεZ≡{x₀, x₁, . . . x_{N-1}} and <cell-id, s=x₀> is equivalent to cell-id itself The non-femto-cell broadcasts the pair of <cell-id, s=x₀>, while the femto-cell broadcasts the pair of <cell-id, s≠x₀>, where x₀ indicates any specific elements in the alphabetic set Z. Thus, by determining whether s=x₀, a femto-cell 104 can be distinguished from a non-femto cell 102.

For a femto-cell, s may be a constant value over a given time window but vary among different time windows. In some embodiments, the time window can be a contiguous time interval containing sufficient copies of s so as to guarantee a certain reception performance by the usage of a soft-combination process. Accurately interpreted in mathematics, the k-th femto-cell can broadcast in i-th time window the identification information <cell-idₖ, sₖⁱ>.

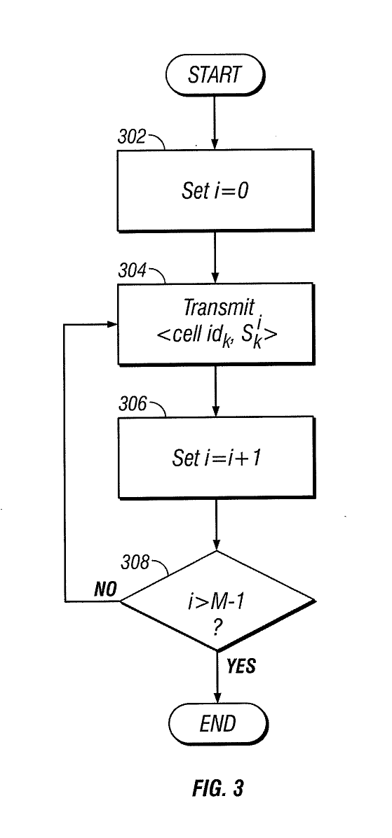

FIG. 3 is a flow diagram illustrating an exemplary method of transmitting a set of values used for femto-cell identification according to one embodiment of the present invention. At block 302, a counter i is initialized to 0 (in this example, the counter i increments from 0 to M−1, where M is the total number of time windows). At block 304, the femto-cell base station 108 then broadcasts <cell-idₖ, sₖⁱ>. The counter i is then incremented at block 306 and compared to the value of M−1 at block 308. The process ends if the value of i is determined to be greater than M−1. Otherwise, the process repeats per block 304.

After detecting M broadcast identification pairs <cell-idₖ, sₖⁱ> (i=0, . . . , M−1) over the M time windows and reporting the identification pairs to the serving non-femto-cell base station 106, the non-femto-cell base station 106 can then combine these reports into a single identification in the form <cell-idₖ, Sₖ(M)>, where Sₖ(M)= [symbol] sₖ⁰, . . . , sₖ^{M-1} [symbol] is the combined series. In this manner <cell-idₖ, Sₖ(M)> can be treated as the full identification of femto-cell 104, as long as for any given M, there is no such j and k that j≠k but Sⱼ(M)=Sₖ(M). Thus, as M increases, the range of possible values for S(M) also increases, thereby yielding a scalable femto-cell identification space.

As far as set mapping is concerned, the alphabet set Z≡{x₀, x₁, . . . x_{N-1}, null} is equivalent to Z≡{0, 1, . . . N−1, null} which means sε[0, N−1] for the purposes of femto-cell identification. In some embodiments, in order to deliver one value out of N candidates, a femto-cell 104 can adopt a signature set whose N member signatures have low cross-correlations as well as certain cell-specific properties. More particularly, in some embodiments, the k-th femto-cell can broadcast in the i-th time window the signature sequence y(sₖⁱ)=a₁·cₖ. In some embodiments, the sequence aᵢ is a sequence set whose N member sequences have low cross-correlations, cₖ is uniquely determined by certain cell specific parameters such as cell-id, and the multiplication aᵢ·cₖ is performed element-wise.

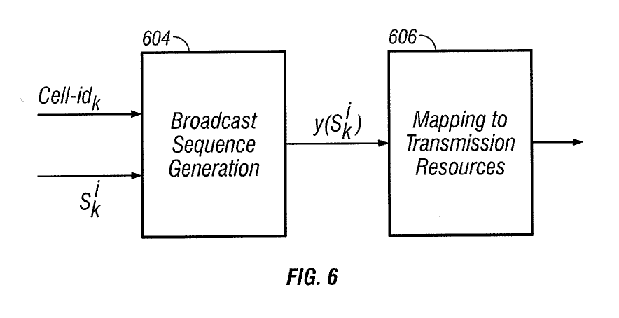

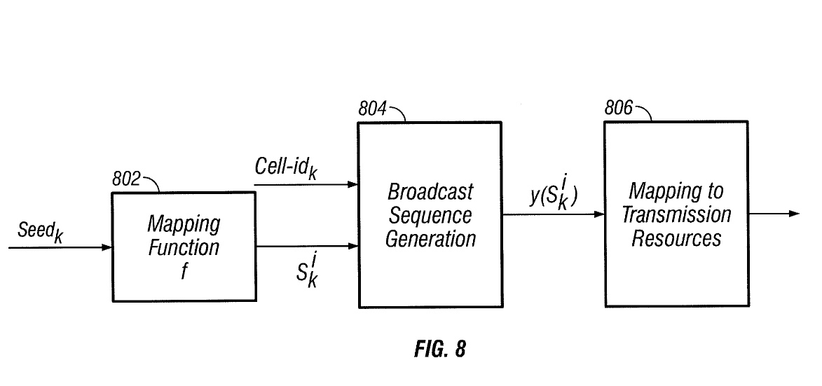

Various realizations for aᵢ and cₖ may be utilized according to the embodiments of the present invention. For example, aᵢ may be an N-ary Walsh sequence or a cyclic-delayed length-N m-sequence (sometimes referred to as a maximum length binary sequence), while cₖ may be realized by an m-sequence whose initial state or state mask or cyclic delay can be uniquely mapped to cell-id. Note that the aforementioned generation of broadcast signaling can be generalized as modules 604 and 804 in FIGS. 6 and 8 respectively (as described and illustrated subsequently). Myriad other realizations are also possible according to embodiments of the invention.

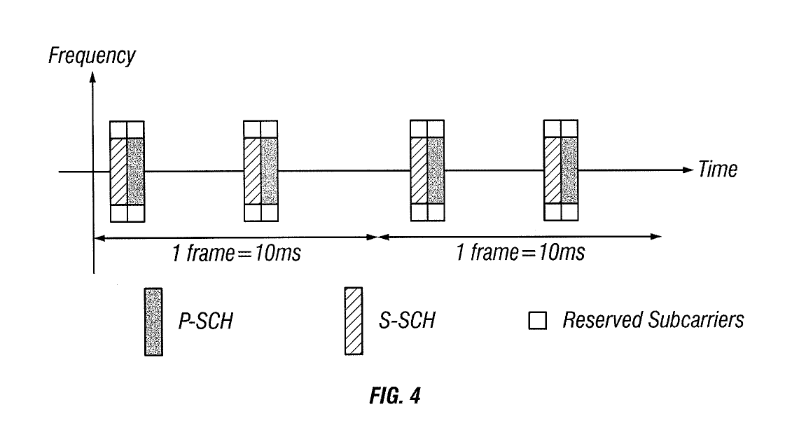

It is also worth noting that the transmission of y(sₖⁱ) in different wireless systems may utilize different resources according to embodiments of the present invention. In a code division multiple access (CDMA) system, for example, y(sₖⁱ) can be carried on one specific CDMA channel by a spread with a specific PN code. In an Orthogonal Frequency Division Multiplexing (OFDM) system, y(sₖⁱ) may be modulated on certain subcarriers within a time-frequency resource block. In a 3GPP LTE/FDD system, the transmission of y(sₖⁱ) can be transmitted on various reserved subcarriers. In one embodiment, for example, forty reserved subcarriers adjacent to a synchronization channel (SCH) are utilized over each ten-millisecond frame. Note that an exemplary process of utilizing reserved subcarriers adjacent to synchronization channels has been illustrated in the exemplary transmission illustrated by FIG. 4. However, myriad other transmissive resources may be utilized to transmit y(sₖⁱ) according to embodiments of the present invention.

An LTE/TDD system can also utilize forty reserved subcarriers adjacent to a synchronization channel per each ten-millisecond frame. In order to maintain backward compatibility in an LTE system, one embodiment of the invention transmits y(sₖⁱ) on all or some of these reserved subcarriers for a given femto-cell 104, but keeps the reserved subcarriers unused for non-femto-cells 102.

In some embodiments, if an N-ary orthogonal sequence is selected to construct y(sₖⁱ), then Nε{2,4,8,16,32}. In other embodiments, if a length-N m-sequence is used, then Nε{3,7,31} but can rounded up to nearest integer power of two by modifying the m-sequence to an M-sequence.

In some embodiments, the sequence is repeated

$$⌊ \frac{40}{N} ⌋$$

times, leaving

$$40 - N \cdot ⌊ \frac{40}{N} ⌋$$

subcarriers still unused. Note that the aforementioned transmission scheme and resource mapping can be generalized as modules 606 and 806 in FIGS. 6 and 8 respectively (as described and illustrated subsequently).

Various strategies may be utilized to select sₖⁱ as a broadcast signature according to embodiments of the present invention. Two such exemplary strategies are detailed below, but myriad other strategies are also possible according to embodiments of the invention.

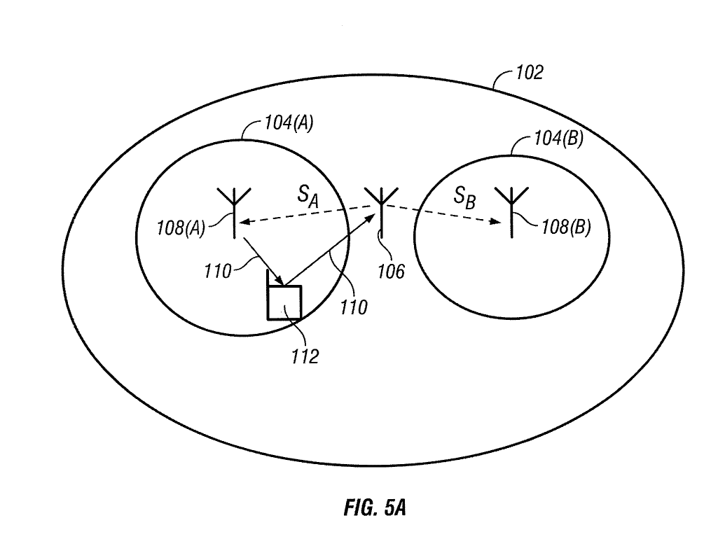

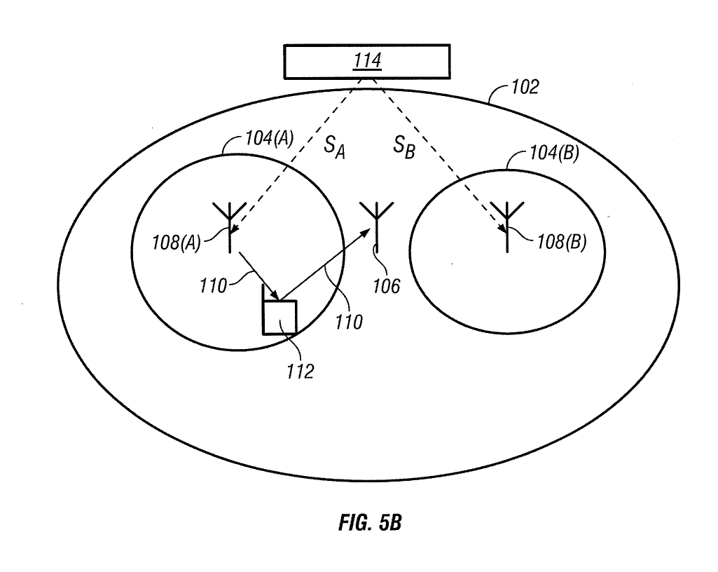

FIGS. 5A and 5B are block diagrams illustrating exemplary femto-cell architectures where network elements directly control the identification broadcast in femto-cell according embodiments of the invention. As shown by the figure, the non-femto-cell 102 illustrates the communicative range of the non-femto-cell base station 106. Two femto-cells 104(A) and 104(B) have been defined by respective femto-cell base stations 108(A) and 108(B) that are each contained within the non-femto-cell 102. Each femto-cell base station 108 may be adapted to communicate with a femto server 114 which may be situated remotely from the non-femto-cell 102.

As shown by these figures, a network element may be used to inform each femto-cell 104 of the s value that should be broadcast (denoted as Sₖ in the figures, where k represents the k-th femto cell 104). For example, in FIG. 5A, the Sₖ values are transmitted to each femto-cell base station 108 by the non-femto-cell base station 108. In FIG. 5B, the Sₖ values are transmitted to each femto-cell base station 108 by the femto-server 114. Various other entities or entity combinations may also be utilized to transmit the Sₖ according to scope of the present invention.

Note that since a femto-cell 104 is allowed to broadcast any one of N non-null values in Z, the total identification space size for a femto-cell is given by N₀·N^{M}, where N₀ is the identification space size of cell-id. Thus, according to some embodiments, the identification space may be increased either by increasing the value of M or by increasing the set of possible values in Z.

FIG. 6 is a block diagram illustrating an exemplary system for generating broadcast signaling for femto-cell identification utilizing the strategy referenced in FIGS. 5A and 5B. As shown by FIG. 6, a module 604 generates the broadcast signaling based upon two input parameters, cell-idₖ and sₖⁱ. The resulting output y(sₖⁱ) is then transmitted to a module 606, which then maps the femto-cell identification to designated transmission resources (for example, to reserved subcarriers according to some embodiments). Note that the modules 604 and 606 can be implemented using any combination of software, hardware, or firmware according to embodiments of the present invention.

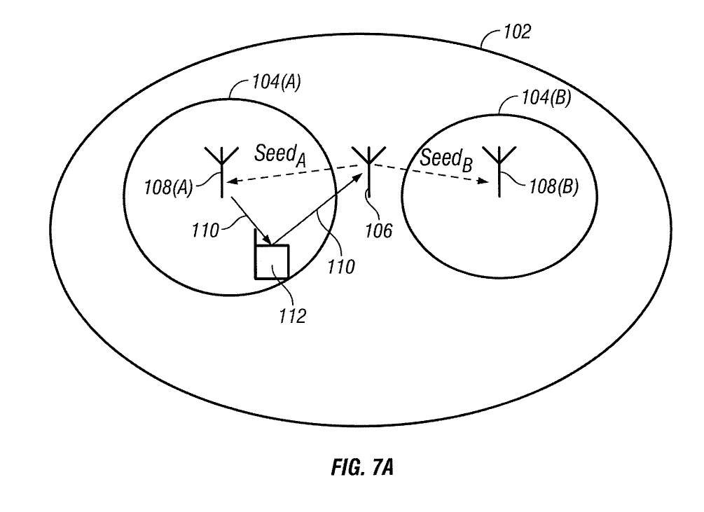

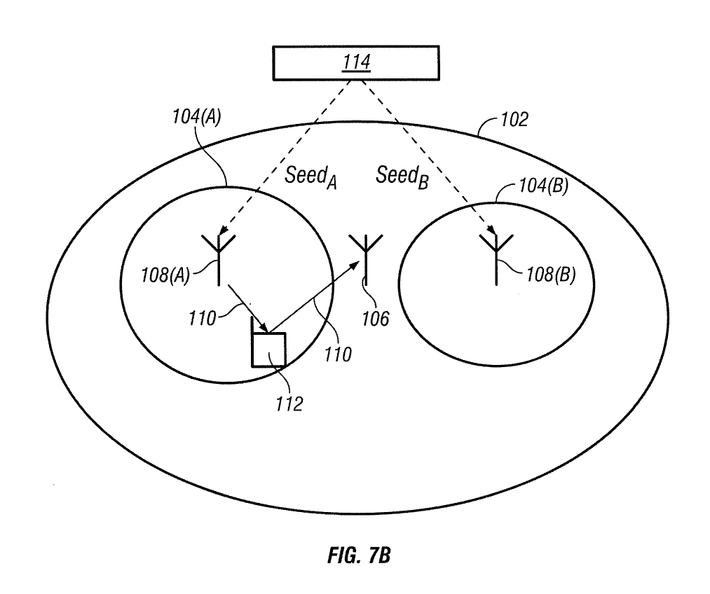

FIGS. 7A and 7B are block diagrams illustrating exemplary femto-cell architectures where network elements control the identification broadcast in femto-cell by a semi-static parameter according to embodiments of the invention. These embodiments can be used, for example, if it is not feasible for the network to dynamically determine the s value that should be broadcast from each femto-cell 104.

In some embodiments, each femto-cell can autonomously generate Sₖ= [symbol] . . . sₖⁱ, sₖⁱ⁺¹ . . . [symbol] according to a mapping function that utilizes a certain semi-static parameter. This semi-static parameter, or “seed”, can be controlled by network elements such as a non-femto-cell base station 106 (as shown, for example, in FIG. 7A) or a femto-server 114 (as shown, for example in FIG. 7B). Various other entities or network elements may be used to control the seed according to embodiments of the present invention.

In some embodiments, the mapping function ƒ: seedₖ→Sₖ is a one-to-one mapping. Thus, the full identification <cell-idₖ, Sₖ> may be equivalent to <cell-idₖ, seedₖ> according to some embodiments.

FIG. 8 is a block diagram illustrating an exemplary system for generating broadcast signaling using semi-static seed control according to one embodiment of the present invention. The mapping function referenced above is processed at a module 802 which may be implemented using any combination of software, firmware, and hardware.

In one embodiment, the module 802 utilizes the following mapping function. For the purposes of this discussion, assume that the seed is in binary form of m bits and only takes non-zero values, and that each non-zero seed maps to an initial state (or equivalently to a cyclic delay or state mask) of a maximum-length sequence (m-sequence) generator constructed by m shift registers. According to this embodiment, every n=log₂ N (where N is integer power of 2) continuous binary bits from the generator output is grouped to form an integer so that the overall generator output binary stream maps to a integer series represented by Sₖ= [symbol] . . . sₖⁱ, sₖⁱ⁺¹ . . . [symbol] .

According to the m-sequence property, any two series of same length M, Sⱼ(M) and Sₖ(M), corresponding to the same sequence delay offset but different initial states (in other words, seedⱼ≠seedₖ) can be guaranteed to be different if

$$M \geq ⌈ \frac{m}{n} ⌉ .$$

In other words, in order to distinguish femto-cells with the same cell-id, the MS needs to detect identification signaling sₖⁱ from

$$M \geq ⌈ \frac{m}{n} ⌉$$

continuous time windows. Note that report bundling of M continuous detection results from a mobile station 112 to a serving non-femto-cell base station 106 may be utilized according to this embodiment.

Comparisons between a dynamic full-control strategy (for example, as depicted in FIGS. 5-6), and a semi-static seed strategy (for example, as depicted in FIGS. 7 and 8) may indicate that certain requirements are satisfied according to embodiments of the present invention. More specifically, if a femto-cell identification space is required to increase by W times in addition to space provided by cell-id, the number of multiple time windows (M) may satisfy

$$M \geq \frac{{log}_{2} W}{{log}_{2} N}$$

for a dynamic full-control strategy, and

$$M \geq ⌈ \frac{{log}_{2} ( W + 1 )}{{log}_{2} N} ⌉$$

for a semi-static seed strategy.

In some embodiments, the semi-static seed strategy has fewer choices for W. In one embodiment, for example, W is the Mersenne Prime in form W=2^{m}−1, where mε{2, 3, 5, 7, 13, 17, 19, 31, . . . }.

Table 1 shows an exemplary relation between certain identification space targets and the number of continuous time windows spent for detection. In some embodiments, for a given N, a much larger identification space is yielded by slightly increasing M.

TABLE 1

| | | Number of continuous time | | | | |
|---|---|---|---|---|---|---|
| Total ID | | window for detection (M) | | | | |
| space size | m | N = 2 | N = 4 | N = 8 | N = 16 | N = 32 |
| 7 · N₀ | 3 | 3 | 2 | 1 | 1 | 1 |
| 31 · N₀ | 5 | 5 | 3 | 2 | 2 | 1 |
| 127 · N₀ | 7 | 7 | 4 | 3 | 2 | 2 |
| (2¹³ − 1) · N₀ | 13 | 13 | 7 | 5 | 4 | 3 |
| (2¹⁷ − 1) · N₀ | 17 | 17 | 9 | 6 | 5 | 4 |
| (2¹⁹ − 1) · N₀ | 19 | 19 | 10 | 7 | 5 | 4 |

A variety of methods may be utilized for determining the starting instance of the time window if the femto-cells 104 are not required to be time-synchronized to an overlaying non-femto-cell 102 according to the scope of the present invention. While five exemplary methods for solving or bypassing the timing issue are discussed herein, many other methods may also be utilized according to the scope of the present invention.

In one embodiment, one frame per each time window is set at the cost of a smaller N. In a second embodiment, the femto-cell base station 108 sends a constant Sₖ={sₖ⁰} over time at the cost of smaller identification space, where the size of the identification space is N·N₀. In a third embodiment, the network elements configure the seeds in a semi-static seed strategy, or sₖⁱ in dynamic full-control strategy, in such a way that if femto-cells 104 k and j have the same cell-id, then Sₖ and Sⱼ generated from these two femto-cells 104 are neither the same nor differentiated by one element shift. In a fourth embodiment, the mobile station 112 performs blind detection for a time window boundary. In a fifth embodiment, two cₖ values, cₖ^{odd} and cₖ^{even}, are created in order to construct signaling y(sₖⁱ) and alternatively utilized in adjacent time windows.

In some embodiments, when a mobile station 112 reports the detection result to a serving non-femto-cell, the mobile station 112 can utilize the existing handoff request signaling to carry the report, and include a time stamp in the accuracy of frame or time window within the report to indicate when the detection is done. In order to reduce the uplink transmission overhead caused by such reporting, the mobile station 112 can bundle multiple detection results into a single report. For example, in a system utilizing the semi-static seed control identification broadcast strategy, the mobile station 112 can place

$$M \geq ⌈ \frac{m}{n} ⌉$$

detection results for M continuous time windows into a single report.

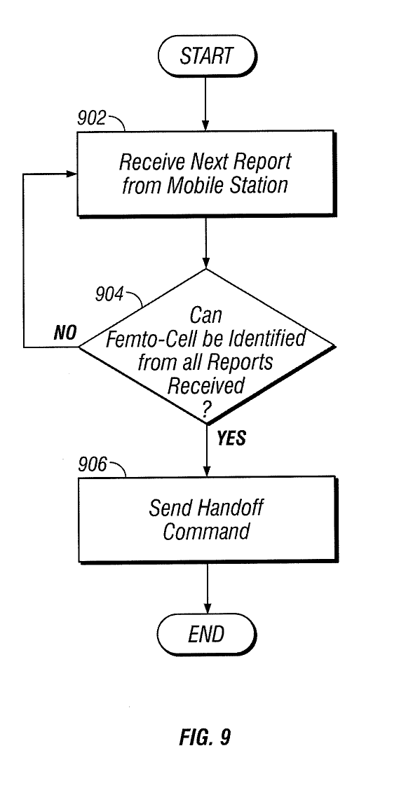

FIG. 9 is a flow diagram illustrating an exemplary method of processing mobile station reports at a non-femto-cell base station 106 according to one embodiment of the present invention. At block 902, the next report from the mobile station is received at the non-femto-cell base station. After receiving the report, the non-femto-cell base station then determines whether the target femto-cell 104 can be unambiguously identified by this report plus previous reports issued from the same mobile station. This is shown at block 904. If the target cell can be unambiguously identified, the non-femto-cell base station sends a handoff command to the mobile station. Otherwise, the non-femto-cell base station waits for the next report at block 902.

In alternative embodiments, if the non-femto-cell base station cannot identify the femto-cell, the non-femto-cell base station then sends a command to the mobile station to request an additional detection report.

In some embodiments, identification performance is controlled by three parameters: the size of non-null alphabet in signature set Z (N), the number of time windows large enough to ensure that the network can unambiguously identify every femto-cell (M), and the number of same identifications broadcast per time window for the purpose of soft-combination in detection (L). Note that L can equal the number of frames per time window according to some embodiments.

In some embodiments, the parameter pair <N,M> determines the total identification space size that increases as either N or M increases, the pair <N,L> determines the detection performance that can be enhanced by reducing N and increasing L, while the pair <M,L> determines the total time expended for detection (as given by M*L). The three-parameters can be adjusted to modify various performance metrics according to embodiments of the invention, and to therefore fit specific application scenarios. These parameters can be sent to the mobile station 112 from the non-femto-cell base station 106 on either a dedicated channel or over common channels.

Note that embodiments of the invention may be implemented in any combination of software, firmware, and hardware. In some embodiments, software or firmware instructions may be stored within one or more machine-readable storage devices that are connected to one or more computers, integrated circuits, or digital processors. In some embodiments, cell identification methods and related signaling processes may be implemented as a sequence of instructions for execution by a processor within a transmitter, receiver, or network controller adapted to perform the described functions and operations.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus for identifying a first cell within a cellular network, the apparatus comprising:
a generator adapted to generate a sequence of broadcasts over a set of time windows, wherein each broadcast within the sequence comprises an input value, and wherein a set of one or more of the input values, when inputted into a femto-cell identification function, identifies the first cell;
transmission mapping logic coupled to the generator and adapted to map each input value onto a transmission resource associated with a network protocol; and
a transmitter coupled to the transmission mapping logic and adapted to broadcast the sequence.

2. The apparatus of claim 1, wherein one or more of the broadcasts within the sequence comprise a cell identification associated with a non-femto-cell that encompasses the first cell.

3. The apparatus of claim 2, wherein the generator is adapted to assign a non-null value to each input value if the first cell is a femto-cell.

4. The apparatus of claim 1, wherein the femto-cell identification function comprises a one-to-one mapping function.

5. The apparatus of claim 4, wherein each input value is adapted to map to a different portion of a femto-cell identifier.

6. The apparatus of claim 1, wherein the generator is adapted to assign a value that does not equal a cell identification associated with a non-femto-cell that encompasses the first cell to each input value in the sequence of broadcasts.

7. The apparatus of claim 1, wherein the generator is adapted to generate the sequence of broadcasts such that each input value is repeated a designated number of times per each time window of the set of time windows.

8. The apparatus of claim 1, wherein the generator is adapted to generate each input value based at least in part upon a sequence set comprising members that exhibit a predetermined level of cross-correlation.

9. The apparatus of claim 8, wherein the sequence set comprises an N-ary orthogonal Walsh sequence set.

10. The apparatus of claim 8, wherein the sequence set comprises a Hadamard sequence set.

11. The apparatus of claim 8, wherein the sequence set comprises a length-N maximum-length binary sequence.

12. The apparatus of claim 1, wherein the generator is adapted to generate the input value based at least in part upon a sequence set associated with an identifier, wherein the identifier is adapted to identify a non-femto-cell that encompasses the first cell.

13. The apparatus of claim 12, wherein the sequence set comprises an m-sequence comprising at least one parameter which uniquely maps to the identifier.

14. The apparatus of claim 12, wherein the sequence set comprises a Gold sequence comprising at least one parameter which uniquely maps to the identifier.

15. The apparatus of claim 1, wherein the transmission resource comprises a reserved subcarrier associated with the network protocol.

16. A computer readable medium comprising instructions which, when executed by a computer, perform a process comprising:
generating a sequence of values adapted to identify a femto-cell when inputted into a femto-cell identification function, wherein said generating a sequence is based at least in part upon multiplying elements of a first sequence set with elements of a second sequence set;
mapping each value to a set of transmission resources associated with a network protocol, wherein the set of transmission resources do not include resources allocated for transmitting a cell identification associated with a non-femto-cell encompassing the femto-cell; and
transmitting the sequence of values to a remote device.

17. The computer readable medium of claim 16, wherein the process further comprises:
receiving a control parameter from a network entity, wherein the control parameter is adapted to facilitate generating the sequence of values.

18. The computer readable medium of claim 17, wherein the control parameter is adapted to determine of the sequence of values upon input to a sequence generation function.

19. The computer readable medium of claim 17, wherein the control parameter comprises a semi-static parameter, and wherein said generating a sequence of input values is based at least in part upon the semi-static parameter.

20. The computer readable medium of claim 17, wherein the set of transmission resources comprises a reserved subcarrier.

21. A method of generating and transmitting a broadcast sequence for identifying a first cell within a cellular network, the method comprising:
generating a sequence of broadcasts within a cellular base station, wherein each broadcast of the sequence comprises a value from a input set determined by multiplying each member of a first sequence set with each member of a second sequence set, and wherein the second sequence set includes at least one parameter that uniquely maps to an identifier associated with a non-femto-cell containing the first cell;
mapping each value to a set of transmission resources within the cellular base station; and
transmitting the sequence from the cellular base station to a first device over a first set of time windows.

22. The method of claim 21, wherein the first sequence set comprises a set of members that exhibit a predetermined level of cross-correlation.

23. The method of claim 21, wherein the remote device is adapted to receive a plurality of broadcasts in the sequence and generate a report to a second device based at least in part upon the plurality of broadcasts.

24. The method of claim 21, further comprising receiving a control parameter at the cellular base station from a network entity, wherein the control parameter is adapted to facilitate generating the sequence of broadcasts.

25. The method of claim 24, wherein the control parameter comprises a semi-static parameter.

26. A method of processing reports issued by a mobile station in order to identify a femto-cell within a cellular network, the method comprising:
receiving in memory a report from a mobile station, wherein the report comprises a set of one or more input values;
processing a set of commands to generate a determination as to whether the femto-cell can be identified, wherein the determination is based upon the set of one or more input values and a set of input values already received;
transmitting a handoff command to a remote device if the determination indicates that the femto-cell can be identified.

27. The method of claim 26 further comprising:
transmitting a request for an additional report to the mobile station if the determination indicates that the femto-cell cannot be identified.
